(19) United States
(12) Patent Application Publication
(10) Pub. No.: US 2004/0259555 A1
(43) Pub. Date: Dec. 23, 2004

(54) System and method for predicting network performance and position location using multiple table lookups

(76) Inventors: Theodore S. Rappaport, Austin, TX (US); Roger R. Skidmore, Austin, TX (US)

Correspondence Address: WHITHAM, CURTIS & CHRISTOFFERSON, P.C., 11491 SUNSET HILLS ROAD, SUITE 340, RESTON, VA, 20190, US

(21) Appl. No.: 10/830,446

(22) Filed: Apr. 23, 2004

Related U.S. Application Data
(60) Provisional application No. 60/464,660, filed on Apr. 23, 2003.

(51) Int. Cl. H04B 1/00; H04B 7/00; H04Q 7/20

(52) U.S. Cl. 455/446; 455/423

(57) ABSTRACT

This invention provides a system and method for the design, prediction, and control of wireless communication networks by combining RF channel data from multiple lookup tables, each of which correlates an RF channel characteristic to some higher order network performance metric. Network performance predictions, and resulting network control instructions, are produced from look-up tables of measured or predicted data relating one or more RF channel characteristics to one or more network performance metrics. These lookup tables are uniquely constructed by site-specific location, technology, wireless standard, or equipment types.

### CROSS-REFERENCE TO RELATED APPLICATIONS

This application claims priority and stems from provisional patent application 60/464,660 filed on Apr. 23, 2003, entitled “A Comprehensive Method and System for the Design and Deployment of Wireless Data Networks.” The disclosed invention is also related to U.S. Pat. No. 6,317,599, U.S. Pat. No. 6,442,507, U.S. Pat. No. 6,493,679, U.S. Pat. No. 6,499,006, U.S. Pat. No. 6,625,454, and U.S. Pat. No. 6,721,769; and the complete contents of these patents are herein incorporated by reference.

### DESCRIPTION

### BACKGROUND OF THE INVENTION

1. Field of the Invention

The present invention generally relates to computerized systems used to predict and manage the network performance characteristics and position location capabilities of wireless communication networks, and more particularly, to a method and system for determining, analyzing, estimating, or measuring the performance of a communications network by combining data from multidimensional table lookups.

2. Background Description

As data communications use increases, radio frequency (RF) coverage within and around buildings and signal penetration into buildings from outside transmitting sources has quickly become an important design issue for network engineers who must design and deploy cellular telephone systems, paging systems, wireless or wired computer networks, or new wireless systems and technologies such as personal communication networks, wireless local area networks (WLANs), ultrawideband networks, RF ID networks, and WiFi/WiMax last-mile wireless networks. Similar needs are merging for wireless Internet Service Providers (WISPs) who need to provision and maintain wireless connections to their customers. Designers are frequently requested to determine if a radio transceiver location or base station cell site can provide reliable service throughout an entire city, an office, building, arena or campus. Emerging network products provide real-time measurement of network behavior and use measured data to self-adjust network performance. A common problem for wireless networks is inadequate coverage, or a “dead zone” in a specific location, such as a conference room. Such dead zones may actually be due to interference, rather than lack of desired signal. It is understood that an indoor Voice over IP (VoIP) wireless PBX (private branch exchange) system or wireless local area network (WLAN) can be rendered useless by interference from nearby, similar systems, or by lack of coverage or throughput in desired locations.

The costs of in-building and microcell devices which provide wireless coverage are diminishing, and the workload for RF engineers and technicians to install and manage these on-premises systems is increasing sharply. Rapid engineering design, deployment, and management methods for microcell and in-building wireless systems are vital for cost-efficient build-out and on-going operation. The evolving wireless infrastructure is moving toward packet-based transmissions, and outdoor cellular may soon complement in-building Wireless LAN technology. See “Wireless Communications: Past Events and a Future Perspective” by T. S. Rappaport, et al., IEEE Communications Magazine, June 2002 (invited); and “Research Challenges in Wireless Networks: A Technical Overview, by S. Shakkottai and T. S. Rappaport at Proceeding of the Fifth International Symposium on Wireless Personal Multimedia Communications, Honolulu, HI, October 2002 (invited).

Analyzing and controlling radio signal coverage penetration, network quality of service, and interference is of critical importance for a number of reasons. As more and more wireless networks are deployed in greater capacity, there will be more interference and more management and control needed, which in turn will create a greater need to properly design, measure, and manage, on an on-going basis, the aggregate performance of these networks, using real time autonomous management systems as well as sporadic or periodic adjustments to the wireless infrastructure. Not only will there be a need for properly setting the channels and operating parameters of indoor networks in an optimal or sensible setting upon network turn-on, but real time control will also be needed to guarantee quality of service to different types of wireless users (different class of users), some who may pay a premium for guaranteed data delivery or a more robust form of wireless network access, and other users who may want a lower class of service and who do not wish to pay for premium bandwidth access or who only need intermittent access to the network. Even if different user classes are not differentiated by payment, certainly the packet-based transmissions and demands of different classes of users (real time versus not-real-time, streaming video versus email, etc.) will require accurate prediction/simulation techniques, bandwidth control, and autonomous provisioning of traffic flows and network control.

Provisioning the Radio Frequency (RF) resources of networks will become more important as users increase and networks proliferate, and scheduling techniques and autonomous control of networks using simpler and more automated and embedded means will be critical for the success and proliferation of ubiquitous wireless networks.

When contemplating a wireless network, such as a Wireless LAN, broadband last-mile WiMax network, a mesh network, or a cellular network to offer service to a group of mobile or portable or fixed users, a design engineer must determine if an existing outdoor large-scale wireless system, or macrocell, will provide sufficient coverage and/or capacity throughout a building, or group of buildings (i.e., a campus), or if new hardware is required within the campus or buildings. Alternatively, network engineers must determine whether local area coverage will be adequately supplemented by other existing macrocells, or whether and where, particularly, indoor wireless transceivers (such as wireless access points, smart cards, sensors, or picocells) must be added. The placement and configuration of these wireless devices is critical from both a cost and performance standpoint, and the on-going maintenance and management of the network and the management of the performance of users on the network is vital to ensure network quality, quality of service (QoS) requirements, as well as reliability and security of the wireless network as more users come on the network or install nearby networks.

Not only must judicious planning be done to prevent new wireless indoor networks from interfering with signals from an outdoor macrocell or other nearby indoor networks at the onset of network deployment, but the designer must currently predict how much interference can be expected and where it will manifest itself within the building, or group of buildings ahead of time the best he or she can. Also, providing a wireless system that minimizes equipment infrastructure cost as well as installation cost is of significant economic importance.

The placement and configuration of wireless and wired equipment, such as routers, hubs, switches, cell sites, cables, antennas, distribution networks, receivers, transceivers, transmitters, repeaters, access points, or RF ID tag readers is critical from both a cost and performance standpoint. The design engineer must predict how much interference can be expected from other wireless systems and where it will manifest itself within the environment. In many cases, the wireless network interferes with itself, forcing the designer to carefully analyze many different equipment configurations in order to achieve proper performance. Sometimes power cabling is only available at limited places in a building or campus, thus decisions must be made with respect to the proper location and quantity of access points, and their proper channel assignments. Prediction methods which are known and which are available in the literature provide well-accepted methods for computing coverage or interference values for many cases.

Depending upon the design goals or operating preferences, the performance of a wireless communication system may involve tradeoffs or a combination of one or more factors. For example, the total area covered with adequate received or radio signal strength (RSSI), the area covered with adequate data throughput levels, and the numbers of customers that can be serviced by the system at desired qualities of service or average or instantaneous bandwidth allocations or delays are among the deciding factors used by network professionals in planning the placement of communication equipment comprising the wireless system, even though these parameters change with time and space, as well as with the number and types of users and their traffic demands.

It should be clear that a highly accurate method for properly determining the appropriate placement of equipment and optimal operating characteristics of a multiple-transmitter network (such as a Wireless LAN with many access points across a campus) is required in the original installation and start-up of a network. Given a reliable method for predicting the radio wave propagation environment and RF channel characteristics for any given location within the physical environment, the interaction between mobile or fixed wireless users and the communications network, the performance of any given proposed or existing communications network can be predicted. This capability enables design engineers and network architects to determine and analyze the performance of a proposed arrangement and configuration of network equipment before an investment is made to deploy the network.

The design of wireless communications up to and including second generation technologies revolved around two factors: ensuring a strong, reliable signal between transmitter and receiver, and ensuring adequate capacity or throughput. Equalizers or RAKE receivers built into air interfaces were assumed to mitigate multipath, leaving only coverage and interference as issues to be concerned with. Coverage with minimal interference was the critical factor in the design of such systems, and the evolution of performance predictive algorithms for wireless communication system design followed suit. However, modern and emerging wireless communication systems require more sophisticated analysis. Data plays a significant role in all modern wireless communication networks. The ability to send and receive information in any form is a key factor in the design and development of next generation wireless protocols and technologies. Throughput, bit error rate (BER), packet error rate (PER, and/or frame error rate (FER) are considered reasonable metrics for the performance of data communication systems, although certainly not the method for quantifying performance. Such systems are dependent on more than just strong signal between transmitter and receiver, being more limited by noise and interference. The performance of a wireless data communication system in terms of throughput, BER, PER, and/or FER may be approximated from the received signal strength intensity (RSSI), system noise (SNR), system interference (SIR), and delay spread levels. Radio frequency (RF) channel characteristics are predictable using well-known techniques to those skilled in the art. Preferred methods for predicting RF channel characteristics are outlined in U.S. Pat. No. 6,317,599 entitled “Method and System for Automated Optimization of Antenna Positioning in 3-D” by Rappaport et al, and in co-pending application Ser. No. ______ entitled “System and Method for Ray Tracing Using Reception Surfaces” by Skidmore et al, both of which are hereby incorporated by reference. If there is then established a reliable transform between the RF channel characteristics and end-user transport layer performance characteristics, the end-user transport layer performance can be reliably predicted.

Given knowledge of the received signal strength relative to the system noise and/or interference along with detailed network information regarding the air interface standards, protocols, and/or the specific combinations of equipment involved, it is possible to predict the ideal throughput for a wireless communication system. However, many protocol standards are vague regarding specific guidelines for the physical and medium access layer. This allows for variability among wireless devices from different vendors. For example, different Wireless LAN (WLAN) vendors make use of different traffic contention protocols with their respective access points. Thus, a wireless modem of a given standard from one manufacturer may provide for much different throughput and performance levels compared to a wireless modem from a separate manufacturer, even when the two modems are placed under the exact same operating conditions. As such, any attempt to accurately represent and predict the throughput, bit error rate, packet error rate, frame error rate, or any other performance metric of a wireless system must be capable of handling variations among separate vendor devices, as well as for variations in the types of services or number of users.

Research efforts by many have attempted to model and predict radio wave propagation. For example, work by AT&T Laboratories, Brooklyn Polytechnic, and Virginia Tech are described in papers and technical reports entitled: S. Kim, B. J. Guarino, Jr., T. M. Willis III, V. Erceg, S. J. Fortune, R. A. Valenzuela, L. W. Thomas, J. Ling, and J. D. Moore, “Radio Propagation Measurements and Predictions Using Three-dimensional Ray Tracing in Urban Environments at 908 MHZ and 1.9 GHz,” IEEE Transactions on Vehicular Technology, vol. 48, no. 3, May 1999 (hereinafter “Radio Propagation”); L. Piazzi, H. L. Bertoni, “Achievable Accuracy of Site-Specific Path-Loss Predictions in Residential Environments,” IEEE Transactions on Vehicular Technology, vol. 48, no. 3, May 1999 (hereinafter “Site-Specific”); G. Durgin, T. S. Rappaport, H. Xu, “Measurements and Models for Radio Path Loss and Penetration Loss In and Around Homes and Trees at 5.85 GHz,” IEEE Transactions on Communications, vol. 46, no. 11, November 1998; T. S. Rappaport, M. P. Koushik, J. C. Liberti, C. Pendyala, and T. P. Subramanian, “Radio Propagation Prediction Techniques and Computer-Aided Channel Modeling for Embedded Wireless Microsystems,” ARPA Annual Report, MPRG Technical Report MPRG-TR-94-12, Virginia Tech, July 1994; T. S. Rappaport, M. P. Koushik, C. Carter, and M. Ahmed, “Radio Propagation Prediction Techniques and Computer-Aided Channel Modeling for Embedded Wireless Microsystems,” MPRG Technical Report MPRG-TR-95-08, Virginia Tech, July 1994; T. S. Rappaport, M. P. Koushik, M. Ahmed, C. Carter, B. Newhall, and N. Zhang, “Use of Topographic Maps with Building Information to Determine Antenna Placements and GPS Satellite Coverage for Radio Detection and Tracking in Urban Environments,” MPRG Technical Report MPRG-TR-95-14, Virginia Tech, September 1995; T. S. Rappaport, M. P. Koushik, M. Ahmed, C. Carter, B. Newhall, R. Skidmore, and N. Zhang, “Use of Topographic Maps with Building Information to Determine Antenna Placement for Radio Detection and Tracking in Urban Environments,” MPRG Technical Report MPRG-TR-95-19, Virginia Tech, November 1995; S. Sandhu, M. P. Koushik, and T. S. Rappaport, “Predicted Path Loss for Roslyn, VA, Second set of predictions for ORD Project on Site Specific Propagation Prediction,” MPRG Technical Report MPRG-TR-95-03, Virginia Tech, March 1995, T. S. Rappaport, et al., “Indoor Path Loss Measurements for Homes and Apartments at 2.4 and 5.85 GHz, by Wireless Valley Communications, Inc., Dec. 16, 1997; Russell Senate Office Building Study, Project Update, Roger R. Skidmore, et al., for Joseph R. Loring & Associates; “Assessment and Study of the Proposed Enhancements of the Wireless Communications Environment of the Russell Senate Office Building (RSOB) and Associated Utility Tunnels,” AoC Contract # Acbr96088, prepared for Office of the Architect of the Capitol, Feb. 20, 1997; “Getting In,” R. K. Morrow Jr. and T. S. Rappaport, Mar. 1, 2000, Wireless Review Magazine; and “Isolating Interference,” by T. S. Rappaport, May 1, 2000, Wireless Review Magazine, “Site Specific Indoor Planning” by R. K. Morrow, Jr., March 1999, Applied Microwave and Wireless Magazine, “Predicting RF coverage in large environments using ray-beam tracing and partitioning tree represented geometry,” by Rajkumar, et al, Wireless Networks, Volume 2, 1996, “Cool Cloud Wireless LAN Design Guildelines and User Traffic Modeling for In-Store Use (Part 1: System Deployment” TR November 2003, WNCG University of Texas by J.K. Chen and T. S. Rappaport, and “Cool Cloud Wireless LAN Design Guildelines and User Traffic Modeling for In-Store Use (Part 2: Traffic Statistics) by C. Na and T. S. Rappaport, November 2003. A. Verstak, N. Ramakrishnan, K.K. Bae, W. H. Tranter, L. T. Watson, J. He, C. A. Shaffer, T. S. Rappaport, “Using Hierarchical Data Mining to Characterize Performance of Wireless System Configurations”, Submitted to ACM Transactions on Modeling and Computer Simulation, August 2002

For the purposes of this document, the term RF channel characteristics shall refer to any measurable parameters that are typically associated with the channel within any communications network Examples of RF channel characteristics include, but are not limited to, RF coverage, received signal strength intensity (RSSI), signal-to-interference (SIR), signal-to-noise (SNR), rms delay spread, angle of arrival, power delay profile, distortion, as well as other well known RF channel characteristics. The terms network performance parameter and transport layer parameters refer to measurable parameters that are typically associated with the media access control (MAC) layer, transport layer, or application layer within a communications network protocol hierarchy. Examples of such parameters include data throughput, or possess other required network system performance values, such as acceptable levels of quality of service (QoS), packet error rate, packet throughput, packet latency, packet jitter, bit error rate, frame error rate, outage, areas of acceptable throughput, and other commonly used communication network performance metrics.

There are several computer aided design (CAD) products on the market that can be used to aid in some manner for wireless design or optimization, but none contemplate the combination of site-specific environment modeling, prediction of RF channel characteristics, and the use of multidimensional tables providing a correlation between RF channel characteristics and other quality of service metrics as described herein. WISE from Lucent Technology, Inc., SignalPro from EDX (now part of Comarco), PLAnet by Mobile Systems International, Inc., (later known as Metapath Software International, now part of Marconi, P.L.C.), decibelplanner from Marconi, and TEMS from Ericsson, Wizard by Safco Technologies, Inc. (now part of Agilent Technologies, Inc.), and IT Guru and SP Guru from OPNET, Inc., are examples of CAD products developed to aid in the design of wireless communication systems.

Agilent Technologies offers Wizard as a design tool for wireless communication systems. The Wizard system predicts the performance of macrocellular wireless communication systems based upon a computer model of a given environment using statistical, empirical, and deterministic predictive techniques.

Lucent Technologies, Inc., offers WiSE as a design tool for wireless communication systems. The WiSE system predicts the performance of wireless communication systems based on a computer model of a given environment using a deterministic radio coverage predictive technique known as ray tracing.

EDX offers SignalPro as a design tool for wireless communication systems. The SignalPro system predicts the performance of wireless communication systems based on a computer model of a given environment using a deterministic RF power predictive technique known as ray tracing.

WinProp offers a Windows-based propagation tool for indoor network planning made by AWE from Germany, and CINDOOR is a European university in-building design tool.

Marconi, P.L.C., offers both PLAnet and decibelplanner as design tools for wireless communication systems. The PLAnet and decibelplanner systems predict the performance of macrocellular and microcellular wireless communication systems based upon a computer model of a given environment using statistical, empirical, and deterministic predictive techniques. PLAnet also provides facilities for optimizing the channel settings of wireless transceivers within the environment, but does not provide for further adaptive transceiver configurations beyond channel settings.

Ericsson Radio Quality Information Systems offers TEMS as a design and verification tool for wireless communication indoor coverage. The TEMS system predicts the performance of indoor wireless communication systems based on a building map with input base transceiver locations and using empirical radio coverage models.

The above-mentioned design tools have aided wireless system designers by providing facilities for predicting the performance of wireless communication systems and displaying the results primarily in the form of flat, two-dimensional grids of color or flat, two-dimensional contour regions. None of the aforementioned design tools contemplate combining site-specific environment models, measured or predicted RF channel characteristics, and multidimensional lookup tables to derive network performance characteristics.

OPNET offers IT Guru and SP Guru as network design and management tools for wireless communication systems. Both provide facilities for managing a logical network layout and for estimating quality of service metrics. Neither IT Guru or SP Guru take into account a site-specific model of an environment, nor do they directly predict physical layer or RF channel characteristics.

In addition, various systems and methods are known in the prior art with the regard to the identification of the location of mobile clients roaming on a wireless network. Such systems and methods are generally referred to as position location techniques, and are well-known in the field for their ability to use the RF characteristics of the transmit signal to or from a mobile device as a determining factor for the position of the mobile device. Various papers such as P. Bahl, V. Padmanabhan, and A. Balachandran, “A Software System for Locating Mobile Users: Design, Evaluation, and Lessons,” April 2000, present various techniques for doing position location from signal strength measurements. Companies such as Wibhu, Ekahau, Polaris Wireless, and the radio camera concept from US Wireless (now defunct), use signal strength to estimate the position of wireless users. U.S. Pat. No. 6,259,924 to Alexander, Jr. et. al., U.S. Pat. No. 6,256,506 to Alexander, Jr., et. al., U.S. Pat. No. 6,466,938 to Goldberg, and Patent application 20020028681 to Lee, et. al., deal with estimating position locations using databases of measurements.

### SUMMARY OF THE INVENTION

The present invention presents a novel approach to the prediction and analysis of communication network performance by combining site-specific environmental models, measured or predicted RF channel characteristics, and multidimensional lookup tables that correlate RF channel characteristics with higher level network performance metrics.

While prior art references describe a comparison of measured versus predicted RF signal coverage, or describe methods for representing and displaying predicted performance data, they do not contemplate a method of correlating site-specific environment models, RF channel characteristics, and quality of service metrics using table look-up tables for the purposes of rapidly and effectively determining or analyzing the performance of a wireless communications network. Furthermore, the ability of using multiple look up tables to determine the position location of users, using relative weightings of data from different look up tables to determine position location or wireless network performance, is novel.

The present invention provides significant benefit to the field of position location by using site-specific propagation prediction to enable the a priori determination of the RF propagation and channel environment within the facility without the need for exhaustive measurement campaigns, and then using this a priori prediction capability in order to build look up table based on the site-specific predictions, or based on in-situ measurements, to provide network performance predictions, including position location, network throughput performance throughout the environment, and predicting outage, BER, PER, FER, and other important metrics over areas of interest.

The predictive capability of the invention enables the correlation of multiple RF channel characteristics to a particular location or over many locations, rather than relying on a single RF channel characteristic to provide input data for estimating network performance. Multiple predicted RF channel characteristics, each of which having a lookup table correlating RF channel parameters to a known or estimated position, can be used with the multiple table lookup mechanism provided by this invention for ready use in carrying out position location computation and displays, or studies or analysis of location-specific data. The current invention allows for on-going measurement (through a network of receivers or access points, for example) or prediction (using site-specific propagation modeling) by the use of multiple tables of data that can be rapidly processed, (e.g. read, looked at, interpolated, etc.) to provide inputs to empirical or theoretical models of performance or position location. Through the use of look-up tables, it becomes possible to make very rapid estimates of network performance parameters with sparse data, thereby enabling real time network control, real-time performance updates, and even chip-level implementation with streamlined architecture to determine network performance, including position location estimates.

Recent interest in wireless data communication systems has sparked research into techniques for deriving system throughput and/or frame error rate given information such as received signal strength, system noise levels, interference, number of users, and the type of service. To date, much of this work has revolved around the collection of measured performance metrics (e.g., throughput, RSSI, SIR, SNR, etc.) and the creation of empirical models that can be represented in lookup tables in order to derive throughput given signal-to-interference ratio (SIR), signal-to-noise ratio (SNR), and/or delay spread on a per technology basis. However, until the present invention, the combination of a powerful site-specific design or measurement environment, a comprehensive method and system for predicting radio wave propagation, and the ability to model vendor-specific distribution system equipment and network parameters in multiple fused look up tables to provide rapid analysis or performance prediction, did not exist.

It should be noted that empirical data can be used to derive an expected or estimated SIR, SNR, throughput, packet error, FER, BER, or delay spread, and these estimated data may then be mapped through a function to estimate a higher order network parameter, such as specific throughput level (See “Cool Cloud” reports by J. Chen and T. S. Rappaport of Fall 2003, for example, and Henty and Rappaport in pending U.S. patent application Ser. No. 09/632,803, these documents hereby incorporated by reference). Methods that use empirical data and curve-fitting of empirical data to yield accurate predicted values are advantageous as they directly account for the performance differences among vendor equipment under similar operating conditions. A comparison of empirical data to the theoretical ideal performance (as specified by the vendor or the air interface standard) also provides the means to evaluate different vendor equipment against one another, the impact of varying numbers of users, and the introduction of users of varying priority class on a per technology basis. In the absence of vendor-provided data or calibration data, it is possible to send known data sequences into a channel, or exploit capabilities built into air interface standards or receiver equipment or operating system, to determine the network performance parameters of interest.

This invention provides a system and method for predicting important network parameters, such as throughput and/or FER, position location, BER, outage, PER, etc. through the use of multiple lookup tables which map or “correlate” RF channel characteristics to higher order network performance metrics of interest. A key aspect of the invention uses multiple lookup tables, and appropriate weighting or correlation of such multiple look up tables, as well as a mapping function which maps one or more input variables in these one or more multiple look up tables (for example, RF channel characteristics such as RSSI, SIR, SNR, delay spread, and other parameters) into a single output variable or multiple output variables (for example, network performance metrics such as throughput, FER, PER, BER, or position location of one or more users). The preferred form of the transform function identifying the mapping between one or more RF channel characteristics and the desired network performance metric or metrics of interest is given in pending application Ser. No. 09/632,803, entitled “System and Method for Design, Measurement, Prediction and Optimization of Data Communication Networks,” filed by T. S. Rappaport, R. R. Skidmore, and Ben Henty (Docket 2560038aa), hereby incorporated by reference.

As in-building wireless LANs, WiMax, and last-mile broadband wireless networks using MiMO and Mesh networking, as well as in-uilding UWB wireless networks proliferate, network performance and position location issues facing network installers, carriers, technicians, and end-uers, and eventually autonomous network controllers, will be resolved quickly, easily, and inexpensively using the current invention. The current invention also displays predicted or measured network performance in a manner easily interpretable by network engineers or technicians.

It is therefore an object of the present invention to use multiple tables of data, which can be called upon in parallel or in serial fashion to provide multiple inputs for a mapping to one or more desired predicted network parameters of interest. Using multiple tables of data, and successive table lookups of this data, we provide a method for designing, measuring, predicting or controlling wireless communication network performance parameters. The resulting system and method can be used in pre-bid, design, and deployment applications, as well as real time and on-going management and visualization of networks and their performance.

According to the present invention, a system is provided for allowing a communication network designer, network user, or autonomous controller to dynamically model a wired or wireless system electronically in any physical environment, by using site-specific models of the physical environment of interest. The method includes the selection and placement of models representing various wireless or optical or baseband communication network hardware components, such as antennas (point, omnidirectional, directional, adaptive, leaky feeder, distributed, etc.), base stations, base station controllers, amplifiers, cables, RF ID tags, RF ID readers, mobile or portable transmitter, receiver or transceiver devices, splitters, attenuators, repeaters, wireless access points, couplers, connectors, connection boxes, splicers, switches, routers, hubs, sensors, transducers, translators (such as devices which convert between RF and optical frequencies, or which convert between RF and baseband frequencies, or which convert between baseband and optical frequencies, and devices which translate energy from one part of the electromagnetic spectrum to another), power cables, twisted pair cables, optical fiber cables, and the like, as well as MIMO systems, and allows the user to visualize, in three-dimensions, the effects of their placement and movement on overall system/network performance throughout the modeled environment. For the purposes of this invention, the term “transceiver” shall be used to mean any network component that is capable of generating, receiving, manipulating, responding to, passing along, routing, directing, replicating, analyzing, and/or terminating a communication signal of some type. The placement of components can be refined and fine-tuned prior to actual implementation of a system or network, wherein performance prediction modeling or measurement may be used for design and deployment; and to ensure that all required regions of the desired service area are blanketed with adequate connectivity, RF coverage, data throughput, or possess other required network system performance values, such as acceptable levels of quality of service (QoS), packet error rate, packet throughput, packet latency, bit error rate, signal-to-noise ratio (SNR), carrier-to-noise ratio (CNR), signal strength or RSSI, rms delay spread, distortion, and other commonly used communication network performance metrics, known now or in the future, which may be measured or predicted and which may be useful for aiding an engineer in the proper installation, design, or ongoing maintenance of a wired or wireless communications network. In the case of an optical or baseband wired network, for example, the placement and performance of components can be visualized within the invention to ensure that proper portions of the environment are supplied with service, so that users within the environment may connect directly (with a hardwired connection) or via a wireless or infrared connection which can be provided throughout the wired network using translators, converters, wireless access points, and other communication components that facilitate frequency translation and wireless access from the wired network. The 2-D and 3-D visualization of system performance as predicted or measured using the method described herein provides network designers and maintenance personnel with tremendous insight into the functioning of the modeled wireless or wired communication system, and represents a marked improvement over previous visualization techniques.

To accomplish the above, a 2-D or 3-D site-specific model of the physical environment is stored as a CAD model in an electronic database. This model may be extensive and elaborate with great detail, or it may be extremely simple to allow low cost and extreme ease of use by non-technical persons wanting to view the physical layout of the network. The physical, electrical, and aesthetic parameters attributed to the various parts of the environment such as walls, ceilings, doors, windows, floors, foliage, buildings, hills, and other obstacles that affect radio waves or which impede or dictate the routing of wiring paths and other wired components may also stored in the database, such as performed using Wireless Valley SitePlanner or LANPlanner products. A representation of the environment is displayed on a computer screen for the designer to view. Note that the network/computer controller may display the screen remotely on a device different than where the computing and prediction is performed (e.g. through Internet web browsing or dedicated video channels), or may display the screen on a monitor which is part of the computer controller which implements the prediction engine and table lookup processing, and network control signals. Furthermore, the computer controller may be distributed among different sites or computer platforms, either in the network or distributed between clients and servers, or co-located or located remotely from the actual network of interest. The designer may view the entire environment in simulated 3-D, zoom in on a particular area of interest, or dynamically alter the viewing location and perspective to create a “fly-through” effect.

Using a mouse or other input positioning device, the designer may select and view various communication hardware device models that represent actual communication system components from a series of pull-down menus. A variety of amplifiers, cables, connectors, and other hardware devices described above which make up any wired or wireless communication system or network may be selected, positioned, and interconnected in a similar fashion by the designer to form representations of complete wireless or wired communication systems. U.S. Pat. No. 6,493,679 entitled “Method and System for Managing a Real-Time Bill of Materials” awarded to Rappaport et al sets forth a preferred embodiment of the method for creating, manipulating, and managing the communication system infrastructure as modeled in the CAD software application.

In the present invention, the designer may use the invention to perform calculations to predict the performance of the communications network modeled within the environment. Performance is defined by any form of measurable criteria and includes, but is not limited to, adequate connectivity, RF coverage, data throughput, or required network system performance values, such as acceptable levels of quality of service (QoS), packet error rate, packet throughput, packet latency, bit error rate, signal-to-noise ratio (SNR), carrier-to-noise ratio (CNR), signal strength or RSSI, desired rms delay spread, distortion, and other commonly used communication network performance metrics, known now or in the future. This process takes the form of applying radio wave propagation techniques to determine one or more RF channel characteristics which are then used as indices into lookup tables that provide a correlation between RF channel characteristics and network performance.

The method presented additionally provides a means for visualizing the predicted performance values overlaid onto and/or embedded within the site-specific model of the environment. The present invention extends the prior art in this area by allowing a designer a quick, 3-D view of performance data overlaying the environment model. U.S. Pat. No. 6,317,599 entitled “Method and System for Automated Optimization of Antenna Positioning in 3-D” awarded to Rappaport et al. sets forth a preferred embodiment of the method for predicting the performance of a communications network within a site-specific model of the environment.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 depicts a flow diagram providing process steps employed in the invention;

FIG. 2 is a three dimensional perspective of a building floor plan;

FIG. 3 is a top-down view of a building floor plan containing transceivers and other communications network infrastructure;

FIG. 4 depicts a set of desired positions at which determination of expected network performance is desired;

FIG. 5 provides an example of a simple network performance lookup table mapping SNR to throughput;

FIG. 6 depicts the process within the present invention of deriving a network performance metric using a multidimensional table lookup;

FIG. 7 depicts the process within the present invention of deriving a network performance metric given multiple predicted or measured RF channel characteristics;

FIG. 8 depicts the display of network performance as predicted by the present invention;

FIG. 9 depicts the preferred methodology for creating a network performance lookup table in the preferred embodiment of the invention;

FIG. 10 depicts an example lookup table with an example piecewise linear fit, an exponential curve fit, and a Bezier spline fit applied.

### DETAILED DESCRIPTION OF A PREFERRED EMBODIMENT OF THE INVENTION

The design of communication systems is often a very complex and arduous task, with a considerable amount of effort required to simply analyze the results of system performance. Using the present method, it is now possible to improve the accuracy and efficiency of the prediction of communication system performance. The present invention is a significant advance over the prior art through its use of a novel method of using look up tables to map RF channel characteristics to higher order network performance metrics.

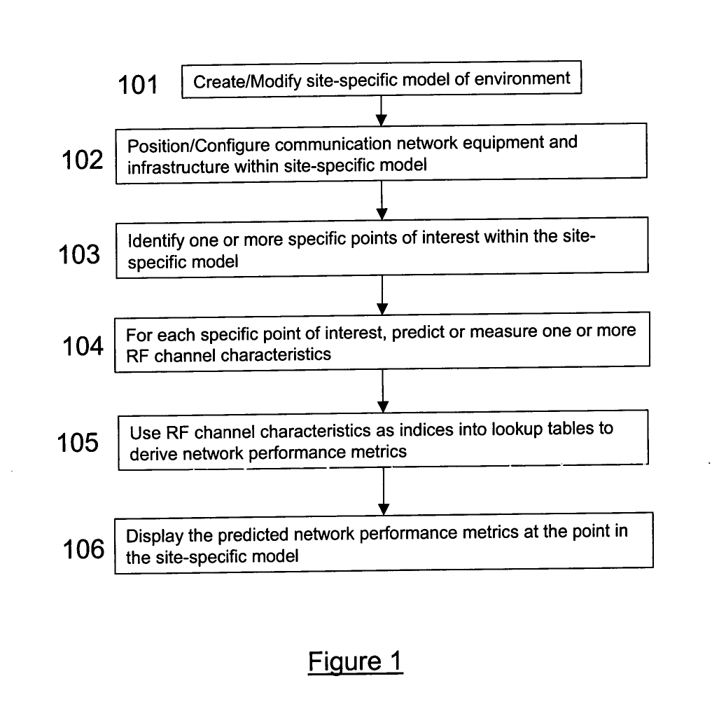

Referring now to FIG. 1, there is shown the general process of the present method. In order to begin analyzing a communication network, a site-specific computer representation of the environment in which the communication network is or will be deployed is created 101. The present invention uses 2-D or 3-D computer aided design (CAD) renditions of a part of a building, a building, or a collection of buildings and/or surrounding terrain and foliage. However, any information regarding the environment is sufficient, including 2-D or 3-D drawings, raster or vector images, scanned images, or digital pictures. The site-specific information is utilized by the present invention to enable visualization and relatively precise positioning of the communications infrastructure in modeling radio wave performance in the environment, and to to provide a model of the environment sufficient for performing visualizations that show the user measurements and/or predictions of network performance or position location information.

According to the invention, there is provided digital site-specific information regarding terrain elevation and land-use, building positions, tower positions, as well as geometries, height, and the internal layout of the walls, doors, ceilings, floors, furniture, and other objects within buildings, where the digital information may be in separate data formats or presentations, including two- or three-dimensional raster or vector imagery, and are combined into a single, three-dimensional digital model of the physical environment. Alternately, a series of 2-D images may be collected to represent the 3-D environment. The resulting three-dimensional digital model combines aspects of the physical environment contained within the separate pieces of information utilized, and is well suited for any form of display, analysis, or archival record of a wireless communication system, computer network system, or may also be used for civil utilities planning and maintenance purposes to identify the location of components, as well as their costs and specifications and attributes.

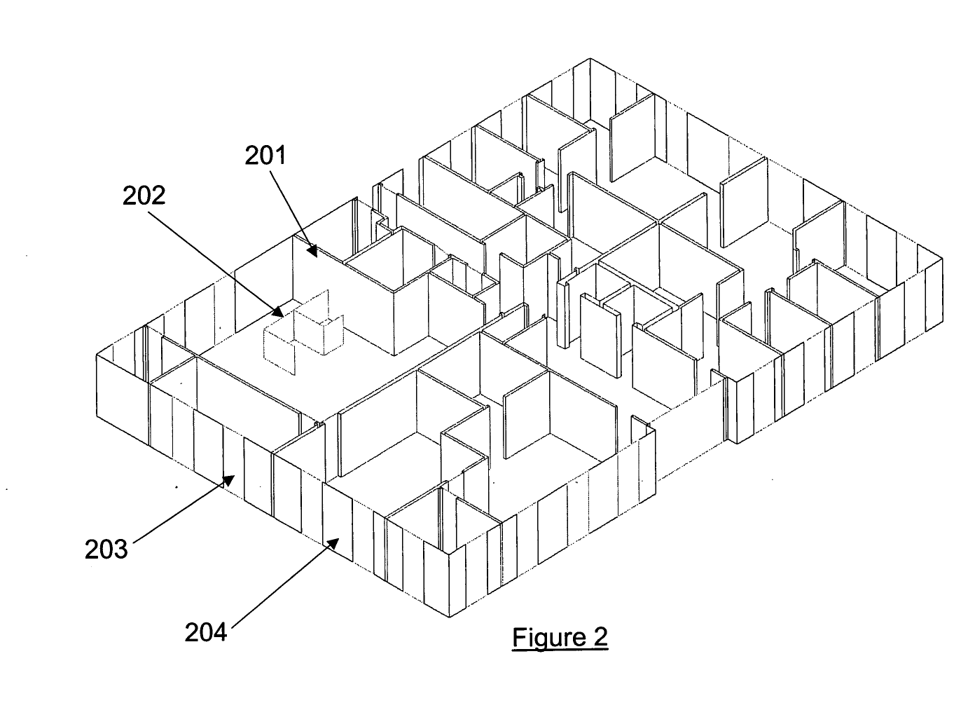

An example of a building environment as represented in the present invention is shown in FIG. 2. The various physical objects within the environment such as external walls 204, internal walls 201, cubicle walls 202, and windows 203 are represented within the model. Although a single floor of one building is shown for simplicity, any number of multi-floored buildings (or portions thereof) and the surrounding terrain may be represented within the invention. Many forms of obstruction or clutter that could impact or alter the performance or physical layout of a communications network can be represented within the present invention. The electrical, mechanical, aesthetic characteristics of all obstructions and objects within the modeled environment may also be input and utilized by the invention. Such data is beneficial for improving the accuracy of performance predictions in wireless networks. For example, for wireless communication system design, the relevant information for each obstruction includes but is not limited to: material composition, size, position, surface roughness, attenuation, reflectivity, absorption, and scattering coefficient. For example, outside walls 204 may be given a 10 dB attenuation loss, signals passing through interior walls 201 may be assigned 3 dB attenuation loss, and windows 203 may show a 2 dB RF penetration loss, depending on their physical characteristics.

This invention also enables a user to specify other physical, electrical, electromagnetic, mechanical, and aesthetic characteristics of any surface or object within the three-dimensional model. These characteristics include but are not limited to: attenuation, surface roughness, width, material, reflection coefficient, absorption, color, motion, scattering coefficients, weight, amortization data, thickness, partition type, owner and cost. In addition, information that is readily readable or writeable in many widely accepted formats, can also be stored within the database structure, such as general location data, street address, suite or apartment number, owner, lessee or lessor, tenant or ownership information, model numbers, service records, maintenance records, cost or depreciation records, accounting records such as purchasing, maintenance, or life cycle maintenance costs, as well as general comments or notes which may also be associated with any individual surface or building or object or piece of infrastructure equipment within the resulting three-dimensional model of the actual physical environment.

Note that all of these types of data specified in the preceding paragraphs typically reside in a computer CAD application which has the ability to iteratively or autonomously compute alternative communication network configurations of all network equipment, based on preset or user-specified design or operating points. However, these data records may also be digitized and passed between and/or stored at individual pieces of hardware equipment in the network for storage or processing at each particular piece of equipment.

Estimated partition electrical properties loss values can be extracted from extensive propagation measurements already published, which are deduced from field experience, or the partition losses of a particular object can be measured directly and optimized or preferred instantly using the present invention combined with those methods described in the U.S. Pat. No. 6,442,507 which is herein incorporated by reference.

Referring once more to FIG. 1, once the appropriate site-specific model of the environment has been specified 101, any desired number of hardware components, communications infrastructure, mobile or portable or fixed wireless devices, or equipment can be positioned, configured, and interconnected in the site-specific model 102. The communications network is site-specifically modeled within the invention by manual or automatic means, whereby the actual physical components used to create the actual physical network are modeled, placed and interconnected graphically, visually, and spatially within the site-specific database model in order to represent their proposed or actual true physical placements within the actual physical environment. This provides a site-specific model of a network of interconnected components within the database model, where such interconnection may be wired or wirelessly connected, using optical, baseband, or RF carrier frequencies.

Associated with at least some of the communication network components (sometimes referred to as infrastructure equipment or hardware) within the database model are infrastructure information, which may be in the form of data records, memory data, files, or text entries which contain the infrastructure information that is uniquely associated with every individual component in space within the modeled environment. That is, three different pieces of the same type of equipment within a network that is modeled within a city using this invention would have three distinct sets of infrastructure information records. The infrastructure information records are stored as either a linked list of textual or numeric information to the graphically represented components, or as data structures that are in some manner tagged or linked to the specific components within the database format.

The infrastructure information for each actual physical component may be represented in a site-specific manner within the environmental model of the physical environment, and such infrastructure information is preferably embedded within the environmental model 102 as described above. The embedding of infrastructure information for actual components may be done either prior to, during, or after the site-specific placement of the modeled components within the database model. The infrastructure information includes but is not limited to graphical objects representing the actual physical locations of infrastructure equipment used in the actual communication system, as well as data describing the physical equipment brand or type, a description of physical equipment location (such as street address, suite or apartment number, owner or tenant, latitude-longitude-elevation information, floor number, basement or subterranean designation, GPS or Snaptrack position location reading, etc.), equipment settings or configurations, desired or specified performance metrics or performance targets for the equipment whereby such desired or specified data are provided by the user or the prediction system, desired or specified performance metrics or performance targets for the network which the equipment is a part of, whereby such desired or specified data are provided by the user or the prediction system, measured performance metrics or network metrics as reported by the equipment, predicted alarm event statistics or outage rates, actual measured alarm event statistics or outage rates, alarm threshold settings or alarm metrics as reported by the equipment or the user or the prediction system, equipment orientation, equipment specifications and parameters, equipment manufacturer, equipment serial number, equipment cost, equipment installation cost, ongoing actual equipment upkeep costs and records, predicted ongoing equipment upkeep costs, equipment use logs, equipment maintenance history, equipment depreciation and tax records, predicted or measured performance metrics, equipment warranty or licensing information, equipment bar codes and associated data, information regarding methods for communicating with the physical equipment for the purposes of remote monitoring and/or alarming, alarm records, malfunction records, periodic or continuous performance or equipment status data, previous or current physical equipment users or owners, contact information for questions or problems with the equipment, information about the vendors, installers, owners, users, lessors, lessees, and maintainers of the equipment, and electronic equipment identifiers such as radio frequency identifiers (RF Ids or RF Tags), internet protocol (IP) addresses, bar codes, or other graphical, wired, or wireless address or digital signature.

The “equipment” or “component” above refers to any actual physical object or device, which may be mechanical or electrical or arterial in nature, or any architectural or structural element of a distributed network, including but not limited to wiring, piping, ducting, arteries, or other distributed components or infrastructure.

While the present invention considers the site-specific database model, adaptive control capabilities, and asset management of a wired or wireless communication network as a preferred embodiment, it should be clear to one of ordinary skill in the art that any infrastructure equipment of a distributed nature, such as structured cabling, piping, or air conditioning could be controlled in such an adaptive manner. Some preferred methods for embedding the infrastructure information within a site-specific environmental model and providing adaptive control is detailed in U.S. Pat. No. 6,493,679, entitled “Method and System for Managing a Real Time Bill of Materials,” awarded to T. S. Rappaport et al, and pending application Ser. No. 09/764,834, entitled “Method and System for Modeling and Managing Terrain, Buildings, and Infrastructure” filed by T. S. Rappaport and R. R. Skidmore which are hereby incorporated by reference.

The resulting combined environmental and infrastructure model, wherein the modeled infrastructure and the associated infrastructure information for each component having been embedded in the environmental model in a site-specific manner, and also embedded in each piece of actual equipment, may then be stored onto any variety of computer media. The combined model is understood to include detailed cost data and maintenance data, as well as specific performance attributes and specific operating parameters of each piece of network hardware, some or all of which may be required for useable predictions and simulations and iterative control of the network. At any point in time, the combined environmental and infrastructure model may be retrieved from the computer media, displayed or processed in a site-specific manner with actual locations of components and component interconnections shown within the environment on a computer monitor, printer, or other computer output device, and/or edited using a computer mouse, keyboard or other computer input device known now or in the future. Furthermore, the combined model may also be embedded in software, or implemented in one or more integrated circuits, for real time or near real-time implementation in a hardware device, portable computer, wireless access point, or other remotely located device.

The editing above may involve changing any of the infrastructure or environmental information contained in the model, including any equipment or operating parameters of particular pieces of hardware that may be altered by the control of the computer CAD application of this invention. Such changes may happen whether the combined model is implemented in chip, embedded software, or standalone form.

Furthermore, the combined environmental and infrastructure models stored on computer media may contain models of infrastructure equipment that are capable of communicating and exchanging data with the CAD computing platform in real-time. For example, the invention may store desired network operating performance parameters that are communicated to certain pieces of actual equipment, and if the equipment ever measures the network performance and finds the performance parameters out of range, an alarm is triggered and reported to the invention for display, storage, processing, and possible remote retuning of pieces of equipment by the invention to readjust the network to move performance back into the desired range. The preferred method of this communication is described in pending application ______ entitled “System and Method for Automated Placement or Configuration of Equipment for Obtaining Desired Network Performance Objectives and for Security, RF Tags, and Bandwidth Provisioning,” by Rappaport et al, which is hereby incorporated by reference. Accessing and utilizing this communication link between the site-specific model of the communication network and the physical equipment can be performed by a variety of means, one of which is detailed in pending application Ser. No. 09/954,273, entitled which is herein incorporated by reference.

The placement of infrastructure equipment may include cables, routers, antennas, switches, access points, and the like, which would be required for a distributed network of components in a physical system. Important information associated with some or all pieces of infrastructure equipment that are modeled by and maintained within the invention using the described database format includes physical location (placement of the equipment within the database so as to site-specifically represent its actual physical placement) as well as data such as equipment vendors, part numbers, installation and maintenance information and history, system or equipment performance and alarm data and history, as well as cost and depreciation information of the specific components and subsystems.

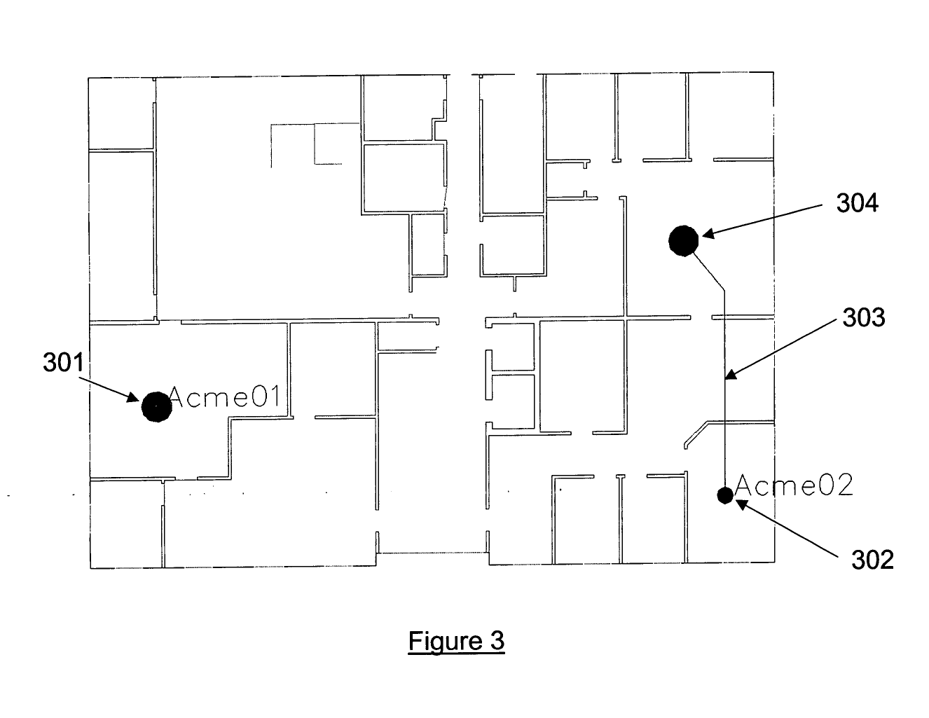

Referring to FIG. 3, there is shown the same site-specific environment as shown in FIG. 2. Using the preferred embodiment of the invention, an example communications network has been defined in FIG. 3. A transceiver 301 has been positioned within the site-specific environment. In addition, the second transceiver 302 has a coaxial cable 303 attached onto it. The coaxial cable 303 has been positioned within the facility and is itself connected to an antenna 304.

Referring to FIG. 1, the present invention provides the user the ability to select one or more points of interest within the site-specific model of the environment, or to identify finite regions of specific interest within the site-specific model of the environment 103. In the preferred embodiment of the invention, this take the form of the user using a mouse or other computer pointing device to indicate one or more specific points of interest within the site-specific environment model, whether by pointing the mouse or otherwise identifying the relevant positions.

Alternately, the user may identify finite regions of interest. Alternately, the user may indicate a desire to select all points meeting a certain criteria, such as all points at which a certain performance metric is achieved or not achieved. Alternatively, the region of interest may be specified automatically or selected by computer control, either based on an earlier preset criterion, preset criteria, or learning techniques that have been found to provide desirable regions of interest.

In the preferred embodiment of the invention, such finite regions take the form of rectangular regions identified through the selection of corner vertices by the user with a mouse; however, one skilled in the art could see that such regions could be of any geometrical shape or size, including but not limited to circular, elliptical, spherical, cylindrical, conical, rhomboid, or any other geometrical shape, and that various input devices or specification mechanisms could be used to control the computer to identify a region of interest. The present invention discretizes the selected region into a set of individual points located within the boundary of the identified region. The set of points created through such a process may be randomly selected from within the region or formed through a regular or irregular matrix of points within the region.

In addition, the present invention may automatically select points of interest based on a desired boundary condition or performance goal. For example, if a desirable network performance characteristic is specified, whether by the user or other mean, to be a certain throughput level (e.g., 11 Mbps), the present invention will search for and identify the point or set of points within the site-specific model at which the desired boundary condition or performance goal exists or is most closely matched by predictions and subsequent table lookups.

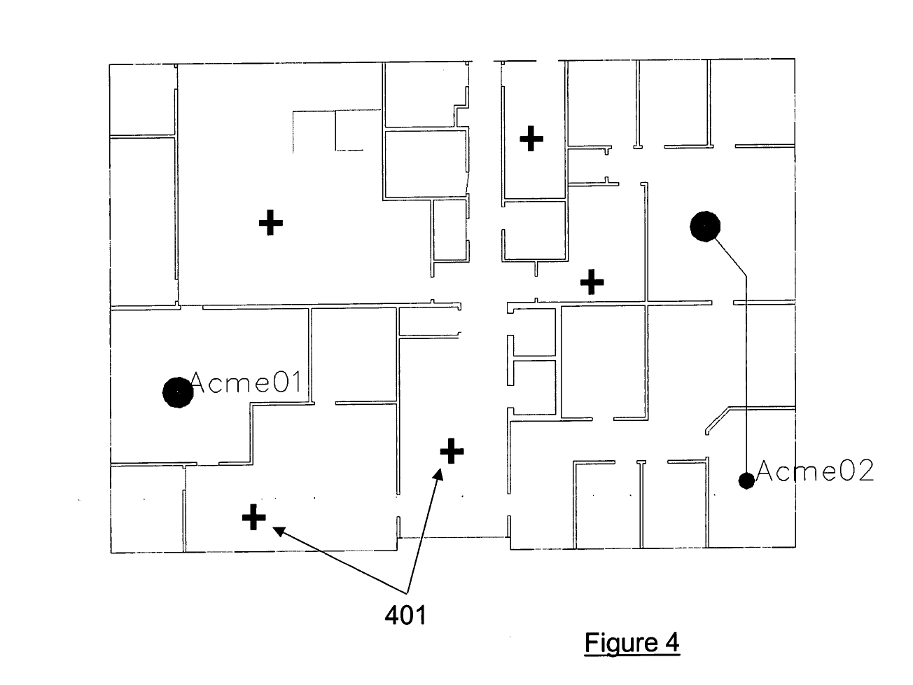

Referring to FIG. 4, there is shown the site-specific environment model from FIG. 2. Points of interest 401 have been selected and are indicated on the site-specific environment model. Referring to FIG. 1, radio wave propagation predictive techniques are used to determine RF channel characteristics at the selected points within the site-specific environment model 104. There are many well-known techniques for predicting radio wave propagation within a site-specific environment model, and one skilled in the art can recognize that any such technique can be applied at this stage in the method of the invention in order to derive one or more RF channel characteristics. Preferred methods for predicting RF channel characteristics are outlined in U.S. Pat. No. 6,317,599 entitled “Method and System for Automated Optimization of Antenna Positioning in 3-D” by Rappaport et al, and in co-pending application Ser. No. ______ entitled “System and Method for Ray Tracing Using Reception Surfaces” by Skidmore, et. al., both of which are hereby incorporated by reference.

Alternately, in addition to or in place of predicting RF channel characteristics, measured RF channel characteristics can be collected 104. There are many well-known techniques for measuring RF channel characteristics in the industry. One method for measuring RF channel characteristics used in the present invention is outlined in U.S. Pat. No. 6,442,507 entitled “System for Creating a Computer Model and Measurement Database of a Wireless Communication Network” by Skidmore et al. Alternatively, the invention may utilize measurements made and collected from a variety of receivers, such as disclosed in patent application Ser. No. 09/632,803, entitled “System and Method for Efficiently Visualizing and Comparing Communication Network System Peformance,” filed by Rappaport, et. al., or may alternatively use measurement and/or control techniques as described in patent application Ser. No. 09/764,834, entitled “Method and System for Modeling and Managing Terrain, Buildings, and Infrastructure” filed by T. S. Rappaport and R. R. Skidmore, or may use measurement systems and techniques as disclosed in patent application Ser. No. 10/015,954, entitled “Textual and Graphical Demarcation of Location, and Interpretation of Measurements” filed by Rappaport, et. al., as well as other patent applications by Wireless Valley Communications, Inc., all hereby incorporated by reference.

Note that as disclosed in the prior art, measurement devices may be able to simultaneously or alternately make RF channel measurements and higher order network performance measurements; e.g., a wireless transceiver (a WLAN card or cellphone, for example) can probe the network with an application-specific transmission, and record the performance of its transmission in the network, thereby collecting throughput and other network performance data, while also being able to measure RF channel data such as RSSI or SNR. Similarly, a wireless transceiver may be equipped with GPS or Snaptrack or some other position location capability, and thus has the ability to make measurements of RF channel characteristics and network performance parameters and position location data. In such cases, the RF channel data and the network performance data and position location data can be placed into tables of data, and processed using table look-ups as described herein.

If one or more specific points of interest have been pre-selected 103, the collected measurements 104 should have been recorded in the same location within the actual environment represented by the site-specific environment model. Note that autonomous measurements can be made by access points or fixed infrastructure, or passed from mobile/portable devices to the computer controller (not shown) via the network.

Once RF channel characteristics have been predicted or measured, lookup tables are used to derive network performance metrics 105. This is done by using the collected RF channel characteristics as indices into lookup tables that map such characteristics into other related performance metrics.

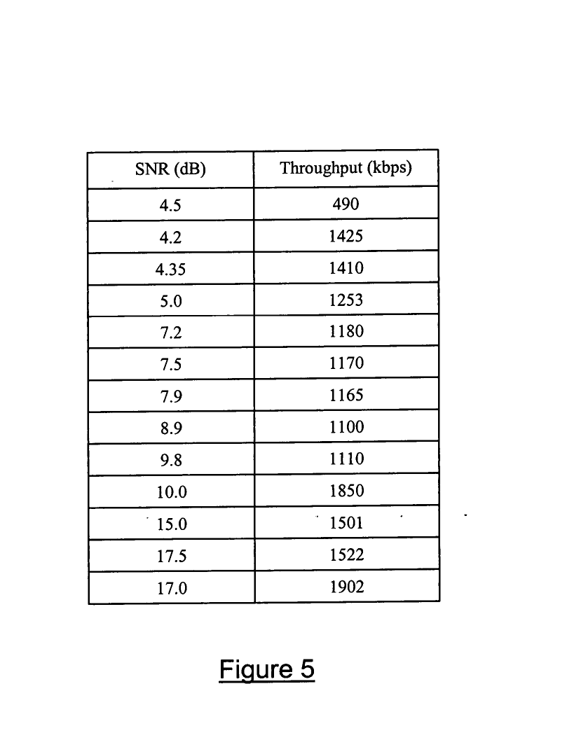

Referring to FIG. 5, there is shown an example table correlating signal-to-noise (SNR) in dB, a well-known RF channel characteristic, to throughput in kilobits per second (kbps). By collecting empirical data for throughput, SIR, SNR, delay spread, frame error rate, or any other such metrics simultaneously, a table such as that in FIG. 5 can be created that correlates the readings on a one-to-one basis. Such a performance lookup table would then enable an observer to derive an expected throughput given a SIR or SNR ratio, or any other such correlation, by simply looking up the given value in the table. To process a performance lookup table such as the one in FIG. 5 that correlates SNR to throughput, a wireless engineer or a computerized apparatus can simply measure or predict a SNR level (through a wide range of measurement techniques described above, or using site specific propagation prediction) and then the computer controller locates, using numerical comparisons, the nearest throughput entry in the chart to determine the approximate throughput when the given level of SNR is present. The more measurement data points that are collected, the less sparse is the table lookup, and the more accurate and useful the data in the chart becomes. The table(s) of data may be processed by interpolation (e.g. curve fitting) or simple “closest table entry” look up, as described subsequently. Such tables can be collected and utilized for any wireless technology (e.g. any technology using any carrier frequency, air interface standard, bandwidth, application, MAC layer, etc.) and used with any site-specific environment, thus providing a convenient and powerful design and control mechanism for any wireless communication network, while providing a large number of tables for particular network configurations. Such tables of data are transportable, and are easily transported along with site-specific information, such as disclosed in U.S. Pat. No. 6,721,769, so that network prediction and network control can be easily used on many computer controllers, or embedded in network switches, and even in integrated circuits.

Although the performance lookup table shown in FIG. 5 depicts a one-to-one relationship between SNR and throughput, a key aspect of the invention is that it is possible for a performance table to correlate a single input characteristic to multiple output characteristics of the same type within the scope of this invention. For example, from predictions or measurements, it may be that a single RSSI value could possibly match to two separate throughput levels, depending on the site-specific location of the measured or predicted value. Likewise, it is possible for a performance table to relate multiple input characteristics to a single output characteristic, for example, the resulting throughput for a particular application may be the same value for two different values of SIR, depending on the specific locations of the measured or predicted values.

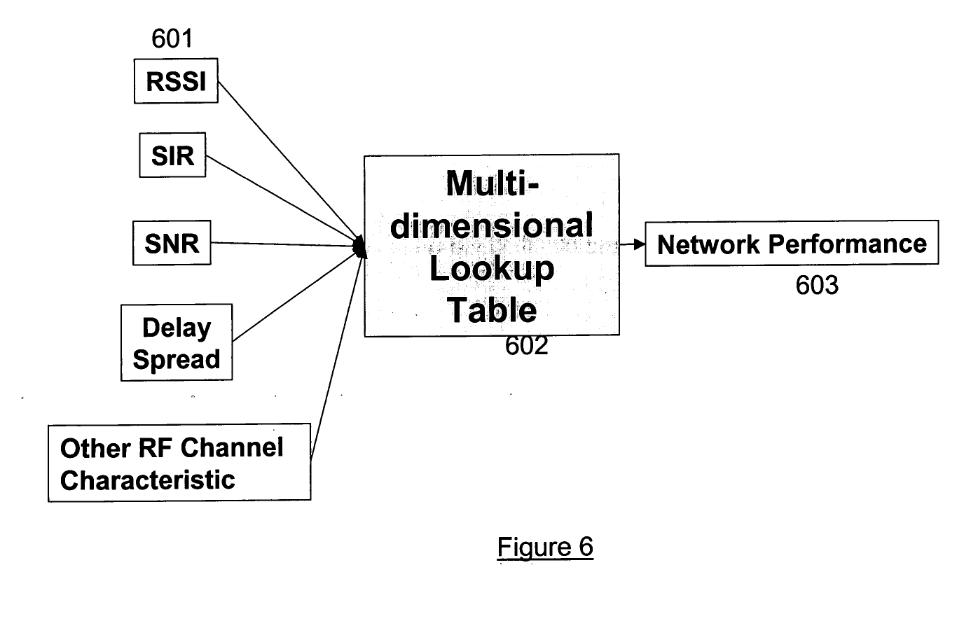

Referring to FIG. 6, there is provided a graphical representation of the general process of deriving network performance parameters from RF channel characteristics. Given one or more RF channel characteristics 601, these are used as indices into a lookup table 602. The lookup table 602 provides a matching given each RF channel characteristic into a single network performance metric. For example, the lookup table 602 may accept RSSI and SIR as inputs that map to a single bit error rate (BER) as the output. The invention supports lookup tables supporting combinations of a wide range of RF channel characteristics as indices mapping to a single output performance parameter. Similarly, position location may be tied to particular RF channel characteristics. By mapping the multiple table lookup inputs to a position location table (not shown), it becomes possible to use the table of values of RF characteristics to map to a position location (either an x,y coordinate, or an x,y,z coordinate, or a gross estimate of location, such as within a room or hallway).

Although the table in FIG. 5 and the process identified in FIG. 6 indicate performance tables wherein the output value is of a single type (for example, bit error rate, or positon location), it can be seen that the lookup tables described herein can also support multiple outputs. For example, a given performance table may correlate delay spread to both throughput and position. Likewise, a separate performance table may correlate both delay spread and SIR to throughput, position, and packet jitter.

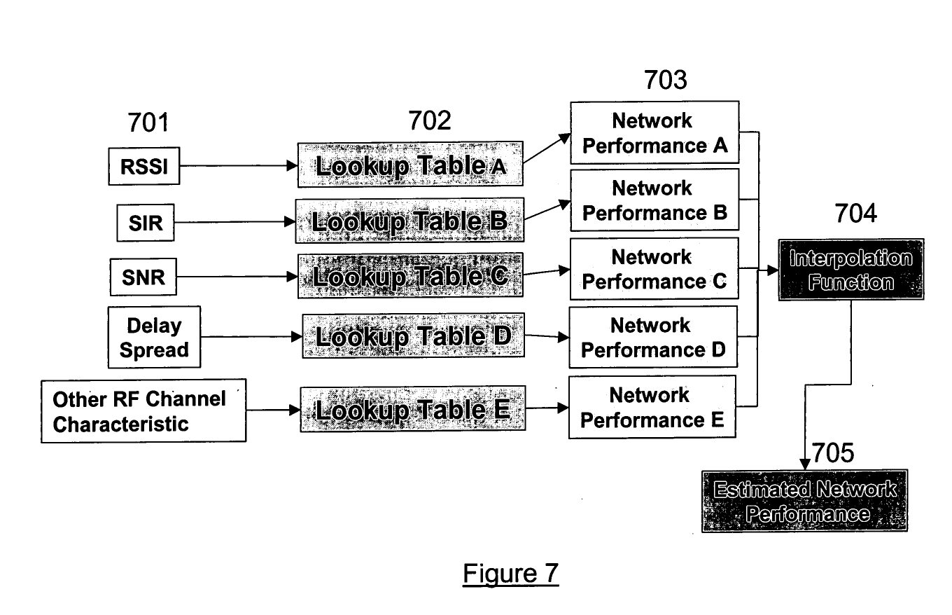

FIG. 7 depicts a more detailed representation of the preferred method of the present invention for utilizing lookup tables. In FIG. 7, various RF channel characteristics 701 have been measured or predicted. For each such RF channel characteristic, there exists a performance lookup table 702 that maps the given RF channel characteristic 701 to a specific network performance metric 703. Each such lookup table 702 may map to a different value of the same performance metric. For example, Lookup Table A maps a specific RSSI level (e.g., −85 dBm) to Network Performance A (e.g., 1.7 Mbps), whereas Lookup Table B maps a specific SIR level (e.g., 10 dB) to Network Performance B (e.g., 1.0 Mbps). The networked performance metrics 703 are then accepted as inputs into an interpolation function 704. The interpolation function 704 then produces a single output value that is accepted as the estimated network performance 705. For example, given Network Performance A to be 1.7 Mbps and Network Performance B to be 1.0 Mbps, the interpolation function may produce 1.1 Mbps as the Estimated Network Performance. The end result is a direct mapping from the RF channel characteristics 701 into a single network performance parameter 706.

Although FIG. 7 depicts only a single level of lookup table 702, it can be seen that multiple levels of lookup tables can be applied within the scope of this invention. For example, the outputs from the lookup tables 702 depicted in FIG. 7 could themselves be used as inputs into other tables that then map to other network performance parameters.

The interpolation function 704 depicted in FIG. 7 can take many forms. The goal of the interpolation function is to calculate a single estimated network performance value 705 given multiple network performance values 703. The present invention allows interpolation functions based on taking a weighted average of the network performance values, a linear average of the network performance values, a non-linear weighting, a heuristical weighting, median filtering, the maximum or minimum of the network performance values, and other methods known now or in the future.

An interpolation function based on a weighted average of the network performance parameters assigns a multiplier to each network performance parameter based on the type of RF channel characteristic used as the input to the lookup table that produced the network performance parameter. These multipliers are referred to as weighting factors. The network performance values 703 are then multiplied by their weighting factor, and the results are linearly averaged to form the estimated network performance metric 705. This provides the means for certain RF channel characteristics to factor more heavily into the calculation of a final estimated network performance parameter than others. The larger the multiplier, the more favored the given value in terms of determining the final estimated network performance. For example, SIR and delay spread may be considered to be more important than RSSI for determination of position location; in this case, the weighting factors for SIR and delay spread will be larger than the weighting factor for RSSI.

An interpolation function based on a linear average of the network performance parameters is equivalent to an interpolation function that considers a weighted average wherein all weighting factors assigned to the network performance parameters 703 are equal to each other. That is, no RF channel characteristic 701 is considered more important than any other.

An interpolation function based upon taking either the maximum or minimum from among the network performance parameters 703 to become the estimated network performance parameter 705 simply selects the largest or the smallest network performance parameter generated by the lookup tables 702. One can easily see how other interpolation functions can also be applied within the scope of this invention.

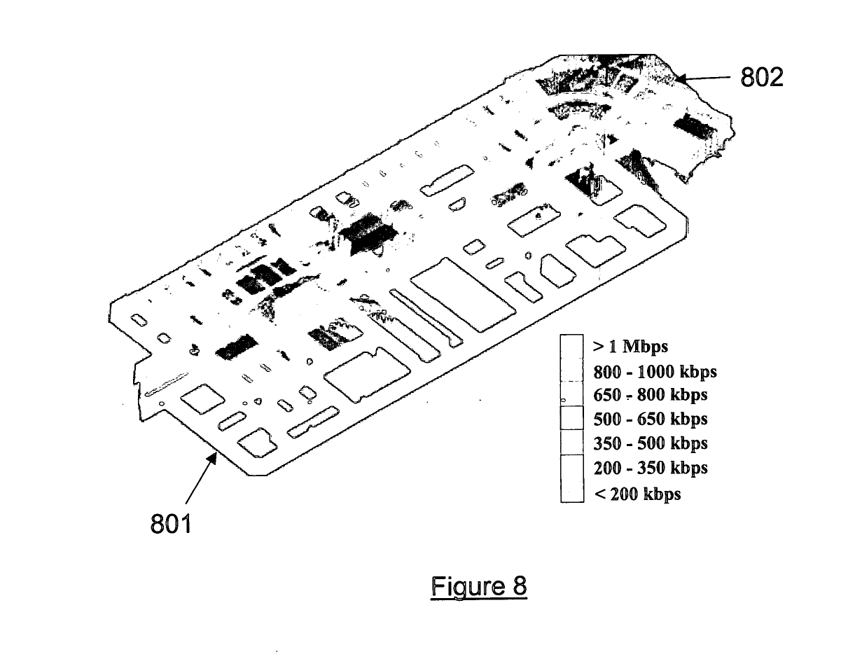

Referring to FIG. 1, once a network performance value has been determined 105, the result is displayed to the user. By associating network performance metrics or radio frequency channel characteristics with some form of graphical icon such as a colored, shaded, or tinted pixel, cursor tooltip, textual string, geometric shape, or any other graphical entity or indicator, and then displaying the graphical icon within the context of the site-specific model, a visual presentation of the radio frequency channel environment or achievable network performance can be displayed at any selected point within the site-specific model. Referring to FIG. 8, there is shown a site-specific model of a building 801 wherein a ray-tracing prediction has been performed. A region of points within the site-specific model has been identified 802, and the network performance at each point has been calculated by predicting the RF channel characteristics for each point given network equipment represented within the site-specific model, and using the predicted RF channel characteristics as input to network performance lookup tables. The calculated network performance is then displayed graphically as a shaded pixel of color 802. The result is a shaded region of color overlaying the site-specific model, wherein the color and other characteristics of the pixels within the region correspond to a certain level of network performance or range of radio frequency channel metrics.

The present invention facilitates the creation of the performance lookup tables described herein. The preferred embodiment of the invention allows the user to define any type of relationship between one or more RF channel characteristics and one or more network performance parameters, between RF channel characteristics, or between network performance parameters on a per technology, per transmitter type, per receiver type, and per application basis. For example, a performance lookup table can be created that relates SIR to throughput for an IEEE 802.11b wireless network utilizing Cisco 340 access points and Lucent Orinoco PCMCIA WLAN modem cards and HP iPAQ handheld PDAs, running Voice over IP. The resulting table may look very different from one that is utilizes an http web browsing application, or an email application, or a Dell Laptop PC as the receiver, on an IEEE 802.11a network, due to the fundamental differences between the equipment types, the application or applications used, the RF carrier frequency, particular network infrastructure components (e.g. antennas or cable loss) or the radio propagation environment in the channel. Through table look ups, the present invention is able to build rapidly accessible records that can be used for a wide range of network performance prediction and control capabilities, based on RF channel issues that are mapped to higher level network models.

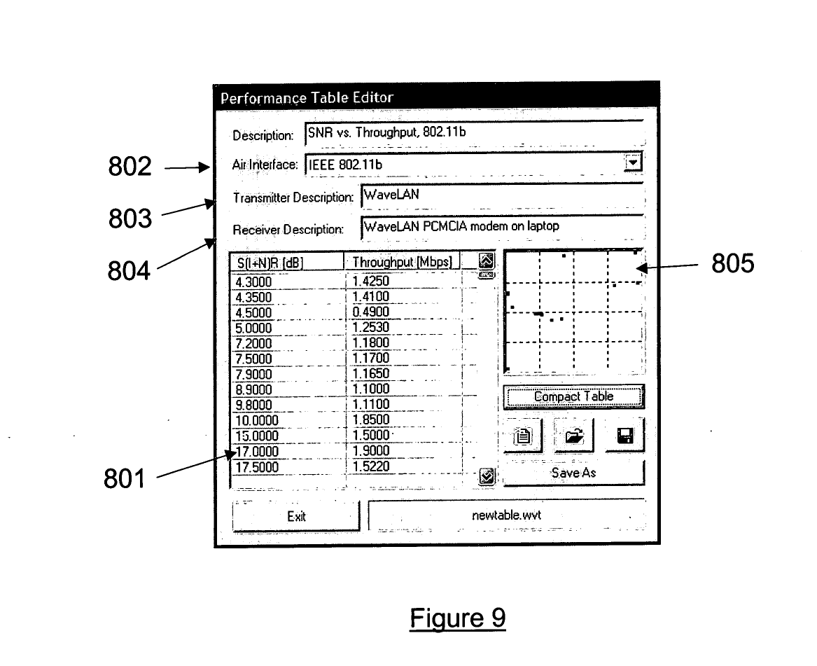

Referring to FIG. 9, there is shown the interface used to create new performance lookup tables within the preferred embodiment of the invention. The input and output values of the table 801 may be entered either manually or through measured or predicted data logs. Specific technology types and wireless standards such as wireless LAN may be identified 802, as can specific combinations of transmitters 803 and receivers 804. Note that detail as specific equipment may not be needed and is not required in the invention, as measurements can provide in-situ responses that nullify the need to know specific hardware configurations. As new table entries are entered, they are displayed graphically in a chart 805. Users may enter any number of chart points in any order. When finalized, network performance tables such as the one depicted in FIG. 9 can be saved in computer memory or some form of electronic media, for later import and usage within the invention.

Wireless equipment from different vendors, even if they were developed for the same wireless standard protocol, can have very different throughput levels while under the same environmental conditions. As a result, some applications of the invention, particularly when comparing different network configurations or providing real time monitoring or control of a network with many users having different equipment, may require including specific hardware data in the lookup tables. In such cases, each lookup table must be associated with a hardware component, such as a wireless LAN access point or cellular base station, as well as other data in order to properly account for the differences between individual pieces of hardware. A preferred method for creating and representing communication network infrastructure and infrastructure components is detailed in U.S. Pat. No. 6,493,679 entitled “Method and System for Managing a Real-Time Bill of Materials” by Rappaport et al, and U.S. Pat. No. 6,625,454 entitled “Method and System for Designing or Deploying a Communications Network Which Considers Frequency Dependent Effects” by Rappaport et al, both of which are hereby incorporated by reference. It should be clear that other methods may also be used to account for distinct differences in different hardware, client devices, etc.

The more RF channel characteristic indices available for use in a network performance lookup table, the more accurate the end result. By definition, a lookup table attempts to create a mapping between input and output metrics. One skilled in the art could see how many different approaches could be taken within the scope of this invention to accommodate RF channel characteristics for which a precise match or interpolation algorithm does not properly fith the lookup indices for a given network performance table.

In order to minimize the likelihood of a given RF channel characteristic not having a closely matching lookup index, the present invention provides the facility to fit various types of curves onto a performance lookup table in order to extrapolate to a much larger number of available input indices and corresponding output values. The types of curve fits supported in the present invention include a piecewise linear fit, an exponential curve fit, and a Bezier spline fit. These three are well-known techniques in the industry for achieving a curve fit to a variety of data sets. One skilled in the art can easily see how other types of curve fits could be applied within the scope of this invention.

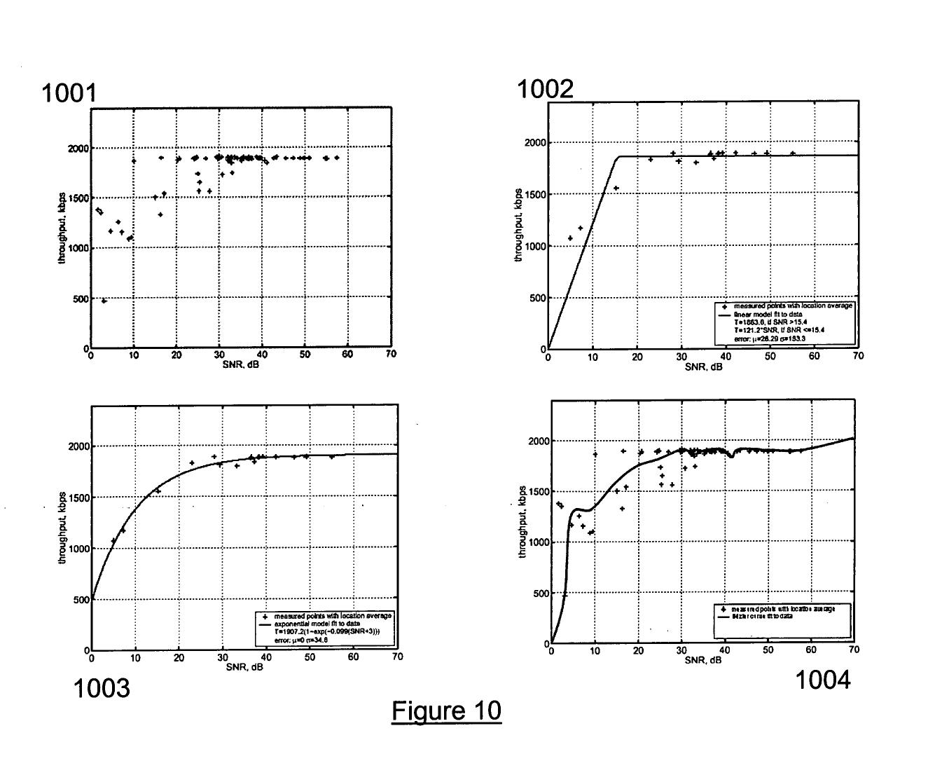

FIG. 10 depicts an example of the three types of curve fits offered by the present invention. A set of empirical data points 1001 are provided that correlate SNR (dB) to throughput (kbps). By applying a piecewise linear fit 1002, exponential curve fit 1003, or Bezier spline fit 1004, a mapping from any input SNR value within the range of the table can now be mapped onto a resulting throughput.

By using the above mentioned network performance prediction methods using tables of data and processed table lookups, it becomes possible to rapidly compute predictions that are site-specific in nature. As disclosed in the prior art, such predictions may then be used to send control signals to equipment or devices in the network, thereby affecting a change (preferably an improvement) in overall network performance or at least for a particular user/device in the network, or a class of users on the network, or allowing more users to be accommodated, etc. In this way, real-time or sporadic, periodic, interrupt-driven, or alarm-based control is easily provided, as the computer controller is able to communicate to network devices/hardware using well-known protocols, as disclosed in some of the Wireless Valley patents cited above.

As wireless networks proliferate, the ability to measure, predict and control network performance will become more embedded within operating systems, and even within the silicon and integrated circuits of wireless devices, themselves. Thus, the disclosed method of table lookups, with their very rapid and easy computational technique, will be easily implemented in pipeline architecture and embedded silicon. In fact, it shall be possible to represent site specific models of a physical environment within memory or on hardware within radios, such information passed to the computer in each mobile device using the computer controller (e.g. the the network controller) which transmits such physical modeling information over the air. It is also possible for the computer controller itself to reside within each radio device, or on the operating system of one or more computers used in a network. Thus, the computer controller (e.g. prediction engine or control device) may actually be within one or more pieces of infrastructure equipment or client device, The above methods for predicting or measuring network performance, using site specific information, will be able to be implemented on a chip or in memory in hardware or in an operating system, and this invention contemplates the ability to use tables of data and table lookups within a chip, or embedded in an operating system, combined with the previously cited Wireless Valley patents and applications, which may also someday be implemented in an on-chip fashion or in an embedded operating system fashion.

While the invention has been described in terms of its preferred embodiments, those skilled in the art will recognize that the invention can be practiced with considerable modification within the spirit and scope of the appended claims.

Having thus described our invention, what we claim as new and desire to secure by Letters Patent is as follows:

1. A site-specific wireless network prediction method, comprising the steps of:
Representing, in a computer, a computerized model of at least one physical environment where at least one in-building or campus network may be installed;
Providing, using a computer, site-specific predictions of network performance or position location for said at least one in-building or campus network using said computerized model, where said site-specific predictions are specified for one or more locations in said computerized model by (a) a human user or (b) by a computer;
Accessing one or more tables of data containing RF channel characteristics, and performing one or more table look-ups on said one or more tables to perform said site-specific predictions of network performance or position location, said table look-ups processed by using either an interpolation function or a “closest table entry” algorithm;
Creating unique tables of data used in said accessing and performing step for one or more of different technologies, applications, specific environments, or hardware configurations for said at least one in-building or campus network;
Displaying the results of said site-specific predictions of network performance or position location in a computer representation of said at least one physical environment.

2. A site-specific wireless network prediction, measurement, or control method, comprising the steps of:
Representing, in a computer, a computerized model of at least one physical environment where at least one in-building or campus network is installed;
Providing, using a computer, either
(a) site-specific predictions of network performance or position location for said at least one in-building or campus network using said computerized model, where said site-specific predictions are specified for one or more locations in said computerized model by a human user or by a computer; or
(b) measurements of network performance or position location or RF channel characteristics for said at least one in-building or campus network, where said measurements are specified for one or more locations in said computerized model by a human user or by a computer;
Accessing one or more tables of data containing RF channel characteristics provided by said providing step, and performing one or more table look-ups on said one or more tables to perform said site-specific predictions of network performance or position location, said table look-ups processed by using either an interpolation function or a “closest table entry” algorithm;
Creating unique tables of data used in said accessing and performing step for one or more of different technologies, applications, site-specific environments, or hardware configurations for said at least one in-building or campus network;
Displaying the results of said site-specific predictions of network performance or position location in a computer representation of said at least one physical environment; and
Providing control signals from a computerized controller to one or more devices in said at least one in-building or campus network to alter the network performance of at least one device operating in said at least one in-building or campus network.
